(19) United States
(12) Patent Application Publication
(10) Pub. No.: US 2025/0133232 A1
(43) Pub. Date: Apr. 24, 2025

(54) METHOD FOR DECODING, SYSTEM, AND METHOD FOR INTRA PREDICTING

(71) Applicant: GUANGDONG OPPO MOBILE TELECOMMUNICATIONS CORP., LTD., Dongguan (CN)

(72) Inventors: Yue YU, Palo Alto, CA (US); Jonathan GAN, Palo Alto, CA (US); Haoping YU, Palo Alto, CA (US)

(21) Appl. No.: 18/856,522

(22) PCT Filed: Apr. 13, 2023
(86) PCT No.: PCT/US2023/018463

§ 371 Date: Oct. 11, 2024

Related U.S. Application Data
(60) Provisional application No. 63/362,957, filed on Apr. 13, 2022.

(51) Int. Cl. H04N 19/593; H04N 19/176; H04N 19/186; H04N 19/70

(52) U.S. Cl. CPC H04N 19/593; H04N 19/176; H04N 19/186; H04N 19/70

(57) ABSTRACT

A method for decoding an intra-predicted frame of a video that is encoded with cross-component prediction includes reconstructing a luma block of a frame of the video from a video bitstream representing the video; reconstructing a chroma block of the frame that corresponds to the luma block based on the reconstructed luma block by: determining a first parameter and a second parameter of a cross-component linear model based on a first set of reconstructed pixels in a chroma component of the frame and a second set of samples generated from reconstructed pixels in a luma component of the frame, decoding, from the video bitstream, a first adjustment to the first parameter and a second adjustment to the second parameter, adjusting the first parameter and the second parameter, and reconstructing pixels of the chroma block; and causing the reconstructed frame to be displayed.

### CROSS-REFERENCE TO RELATED APPLICATIONS

This application is National Stage of International Application No. PCT/US2023/018463, filed on Apr. 13, 2023, which claims priority to U.S. Provisional Application No. 63/362,957, filed on Apr. 13, 2022, which are hereby incorporated in their entireties by reference.

### TECHNICAL FIELD

This disclosure relates generally to video processing. Specifically, the present disclosure involves a method for decoding, a system, and a method for intra predicting.

### BACKGROUND

The ubiquitous camera-enabled devices, such as smartphones, tablets, and computers, have made it easier than ever to capture videos or images. However, the amount of data for even a short video can be substantially large. Video coding technology (including video encoding and decoding) allows video data to be compressed into smaller sizes thereby allowing various videos to be stored and transmitted. Video coding has been used in a wide range of applications, such as digital TV broadcast, video transmission over the Internet and mobile networks, real-time applications (e.g., video chat, video conferencing), DVD and Blu-ray discs, and so on. To reduce the storage space for storing a video and/or the network bandwidth consumption for transmitting a video, it is desired to improve the efficiency of the video coding scheme.

### SUMMARY

In one example, a method for decoding an intra-predicted frame of a video that is encoded with cross-component prediction includes reconstructing a luma block of a frame of the video from a video bitstream representing the video and reconstructing a chroma block of the frame that corresponds to the luma block based on the reconstructed luma block. Reconstructing the chroma block includes determining a first parameter and a second parameter of a cross-component linear model based on a first set of reconstructed pixels in a chroma component of the frame and a second set of samples generated from reconstructed pixels in a luma component of the frame, decoding, from the video bitstream, a first adjustment to the first parameter and a second adjustment to the second parameter, adjusting the first parameter and the second parameter by applying the first adjustment to the first parameter and applying the second adjustment to the second parameter, and reconstructing pixels of the chroma block by applying, to the luma block, the cross-component linear model with the adjusted first parameter and the adjusted second parameter. The method further includes causing the reconstructed frame to be displayed.

In another example, a system includes a processing device and a non-transitory computer-readable medium communicatively coupled to the processing device. The processing device is configured to execute program code stored in the non-transitory computer-readable medium and thereby perform operations. The operations include reconstructing a luma block of a frame of a video that is encoded with cross-component prediction from a video bitstream representing the video; reconstructing a chroma block of the frame that corresponds to the luma block based on the reconstructed luma block; and causing the reconstructed frame to be displayed. Reconstructing the chroma block includes determining a first parameter and a second parameter of a cross-component linear model based on a first set of reconstructed pixels in a chroma component of the frame and a second set of samples generated from reconstructed pixels in a luma component of the frame, decoding, from the video bitstream, a first adjustment to the first parameter and a second adjustment to the second parameter, adjusting the first parameter and the second parameter by applying the first adjustment to the first parameter and applying the second adjustment to the second parameter, and reconstructing pixels of the chroma block by applying, to the luma block, the cross-component linear model with the adjusted first parameter and the adjusted second parameter.

In yet another example, a method for intra predicting a frame of a video with cross-component prediction includes, for each block of the frame, encoding a luma block of the frame of the video; performing intra prediction for a chroma block of the frame that corresponds to the luma block; and encoding the first adjustment to the first parameter and the second adjustment to the second parameter into a bitstream representing the video. Performing intra prediction for a chroma block includes determining a first parameter and a second parameter of a cross-component linear model based on a first set of reconstructed pixels in a chroma component of the frame and a second set of samples generated from reconstructed pixels in a luma component of the frame that corresponds to the first set of reconstructed pixels in the chroma component, determining a first adjustment to the first parameter and a second adjustment to the second parameter, and generating a prediction for the chroma block by applying, to the luma block, the cross-component linear model with an adjusted first parameter by the first adjustment and an adjusted second parameter by the second adjustment.

### BRIEF DESCRIPTION OF THE DRAWINGS

Features, embodiments, and advantages of the present disclosure are better understood when the following Detailed Description is read with reference to the accompanying drawings.

FIG. 1 is a block diagram showing an example of a video encoder configured to implement embodiments presented herein.

FIG. 2 is a block diagram showing an example of a video decoder configured to implement embodiments presented herein.

FIG. 3 depicts an example of a coding tree unit division of a picture in a video, according to some embodiments of the present disclosure.

FIG. 4 depicts an example of a coding unit division of a coding tree unit, according to some embodiments of the present disclosure.

FIG. 5 depicts an example of a current chroma block and corresponding luma block for cross-component linear modeling, according to some embodiments of the present disclosure.

FIG. 6 depicts an example of a linear model for cross-component prediction and the model adjustment, according to some embodiments of the present disclosure.

FIG. 7 depicts an example of a process for performing intra prediction for a frame of a video with cross-component prediction, according to some embodiments of the present disclosure.

FIG. 8 depicts an example of a process for decoding an intra-predicted frame of a video that is encoded with cross-component prediction, according to some embodiments of the present disclosure.

FIG. 9 depicts an example of a computing system that can be used to implement some embodiments of the present disclosure.

### DETAILED DESCRIPTION

Various embodiments provide cross-component linear model (CCLM) adjustment for video coding. As discussed above, more and more video data are being generated, stored, and transmitted. It is beneficial to increase the efficiency of the video coding technology. One way to do so is through intra prediction where the prediction of video pixels or samples in a block within a current frame to be decoded is performed using pixels or samples from the spatial neighboring of the block in the same frame which have already been reconstructed. For typical video content, local correlations can also be observed between the signals of different color components. For example, there may exist strong correlations between luma pixels and corresponding chroma pixels. In some coding standard, the cross-component prediction (CCP) tool exploits these correlations using a linear luma-to-chroma prediction model in the residual domain, where the parameters of the model are signaled in the bit stream. Because the cross-component linear model is derived by minimizing a pre-defined error measure with the chroma and luma samples from the neighbouring templates, instead of using chroma and luma samples from the current block, the derived model may be inaccurate, leading to large prediction errors and low coding efficiency.

Various embodiments described herein address these problems by allowing the cross-component linear model to be determined for a chroma block based on the luma and chroma pixels of the block, rather than neighbouring pixels, thereby leading to a more accurate cross-component linear model. The information about the determined cross-component linear model can be transmitted in the video bitstream so that the decoder has sufficient information for decoding. For example, a video encoder can be configured to determine the parameters of a base cross-component linear model for a block based on chroma pixels and luma pixels that are available at the decoder when decoding the current block. For example, the encoder can use the reconstructed luma pixels that neighbor the luma block and reconstructed chroma pixels that neighbor the chroma block. The encoder can further determine the more accurate actual cross-component linear model based on the chroma and luma pixels of the current block. The difference between the corresponding parameters of the two models can be determined as adjustments to the model parameters. Both adjustments to the slope and offset parameters can be transmitted in the video bitstream to allow the decoder to update the base model to a more accurate model for decoding.

At the decoding side, a video decoder can determine the slope and offset parameters of a base cross-component linear model based on reconstructed neighboring chroma and luma pixels of the current block in the same way as the encoder. The video decoder can further decode, from the video bitstream, the adjustments to the parameters of the cross-component linear model. The decoder updates the base cross-component linear model with the obtained slope and offset adjustments and apply the updated cross-component linear model to the reconstructs luma pixels in the current block to generate reconstructed chroma pixels for the current block.

As described herein, some embodiments provide improvements in video coding efficiency through adjusting the cross-component linear model by taking into account the chroma pixels and reconstructed luma pixels of the current block. Because the cross-component linear model for the block is derived based on the chroma and luma pixels of the current block, rather than the neighboring chroma and luma pixels, the cross component intra prediction is more accurate, and the reconstructed block has lower prediction errors. As a result, the video coding efficiency can be improved. The techniques can be an effective coding tool in future video coding standards.

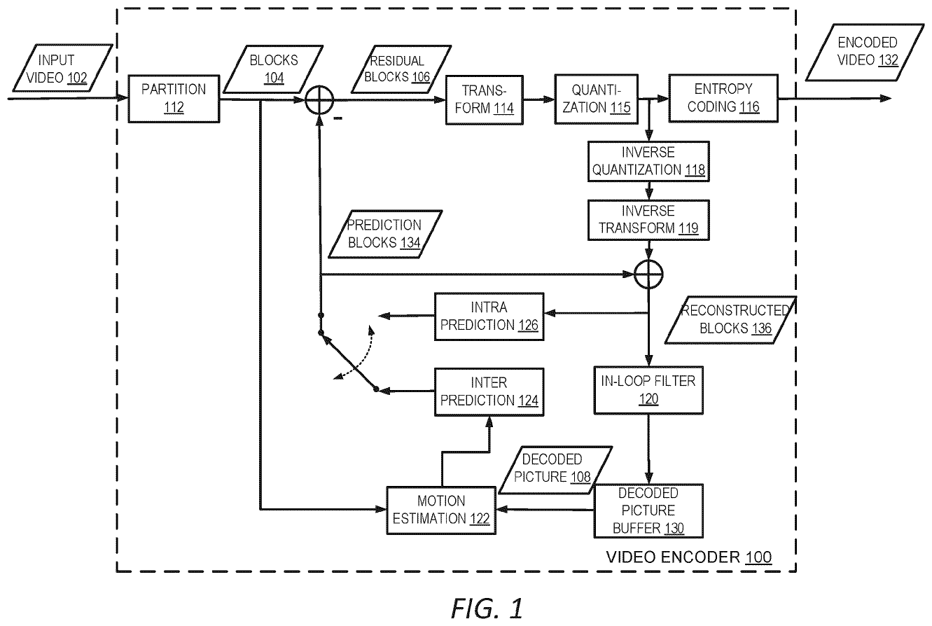

Referring now to the drawings, FIG. 1 is a block diagram showing an example of a video encoder 100 configured to implement embodiments presented herein. In the example shown in FIG. 1, the video encoder 100 includes a partition module 112, a transform module 114, a quantization module 115, an inverse quantization module 118, an inverse transform module 119, an in-loop filter module 120, an intra prediction module 126, an inter prediction module 124, a motion estimation module 122, a decoded picture buffer 130, and an entropy coding module 116.

The input to the video encoder 100 is an input video 102 containing a sequence of pictures (also referred to as frames or images). In a block-based video encoder, for each of the pictures, the video encoder 100 employs a partition module 112 to partition the picture into blocks 104, and each block contains multiple pixels. The blocks may be macroblocks, coding tree units, coding units, prediction units, and/or prediction blocks. One picture may include blocks of different sizes and the block partitions of different pictures of the video may also differ. Each block may be encoded using different predictions, such as intra prediction or inter prediction or intra and inter hybrid prediction.

Usually, the first picture of a video signal is an intra-coded picture, which is encoded using only intra prediction. In the intra prediction mode, a block of a picture is predicted using only data that has been encoded from the same picture. A picture that is intra-coded can be decoded without information from other pictures. To perform the intra-prediction, the video encoder 100 shown in FIG. 1 can employ the intra prediction module 126. The intra prediction module 126 is configured to use reconstructed samples in reconstructed blocks 136 of neighboring blocks of the same picture to generate an intra-prediction block (the prediction block 134). The intra prediction is performed according to an intra-prediction mode selected for the block. The video encoder 100 then calculates the difference between block 104 and the intra-prediction block 134. This difference is referred to as residual block 106.

To further remove the redundancy from the block, the residual block 106 is transformed by the transform module 114 into a transform domain by applying a transform on the samples in the block. Examples of the transform may include, but are not limited to, a discrete cosine transform (DCT) or discrete sine transform (DST). The transformed values may be referred to as transform coefficients representing the residual block in the transform domain. In some examples, the residual block may be quantized directly without being transformed by the transform module 114. This is referred to as a transform skip mode.

The video encoder 100 can further use the quantization module 115 to quantize the transform coefficients to obtain quantized coefficients. Quantization includes dividing a sample by a quantization step size followed by subsequent rounding, whereas inverse quantization involves multiplying the quantized value by the quantization step size. Such a quantization process is referred to as scalar quantization. Quantization is used to reduce the dynamic range of video samples (transformed or non-transformed) so that fewer bits are used to represent the video samples.

The quantization of coefficients/samples within a block can be done independently and this kind of quantization method is used in some existing video compression standards, such as H.264, and HEVC. For an N-by-M block, some scan order may be used to convert the 2D coefficients of a block into a 1-D array for coefficient quantization and coding. Quantization of a coefficient within a block may make use of the scan order information. For example, the quantization of a given coefficient in the block may depend on the status of the previous quantized value along the scan order. In order to further improve the coding efficiency, more than one quantizer may be used. Which quantizer is used for quantizing a current coefficient depends on the information preceding the current coefficient in the encoding/decoding scan order. Such a quantization approach is referred to as dependent quantization.

The degree of quantization may be adjusted using the quantization step sizes. For instance, for scalar quantization, different quantization step sizes may be applied to achieve finer or coarser quantization. Smaller quantization step sizes correspond to finer quantization, whereas larger quantization step sizes correspond to coarser quantization. The quantization step size can be indicated by a quantization parameter (QP). Quantization parameters are provided in an encoded bitstream of the video such that the video decoder can access and apply the quantization parameters for decoding.

The quantized samples are then coded by the entropy coding module 116 to further reduce the size of the video signal. The entropy encoding module 116 is configured to apply an entropy encoding algorithm to the quantized samples. In some examples, the quantized samples are binarized into binary bins and coding algorithms further compress the binary bins into bits. Examples of the binarization methods include, but are not limited to, a combined truncated Rice (TR) and limited k-th order Exp-Golomb (EGk) binarization, and k-th order Exp-Golomb binarization. Examples of the entropy encoding algorithm include, but are not limited to, a variable length coding (VLC) scheme, a context adaptive VLC scheme (CAVLC), an arithmetic coding scheme, a binarization, a context adaptive binary arithmetic coding (CABAC), syntax-based context-adaptive binary arithmetic coding (SBAC), probability interval partitioning entropy (PIPE) coding, or other entropy encoding techniques. The entropy-coded data is added to the bitstream of the output encoded video 132.

As discussed above, reconstructed blocks 136 from neighboring blocks are used in the intra-prediction of blocks of a picture. Generating the reconstructed block 136 of a block involves calculating the reconstructed residuals of this block. The reconstructed residual can be determined by applying inverse quantization and inverse transform to the quantized residual of the block. The inverse quantization module 118 is configured to apply the inverse quantization to the quantized samples to obtain de-quantized coefficients. The inverse quantization module 118 applies the inverse of the quantization scheme applied by the quantization module 115 by using the same quantization step size as the quantization module 115. The inverse transform module 119 is configured to apply the inverse transform of the transform applied by the transform module 114 to the de-quantized samples, such as inverse DCT or inverse DST. The output of the inverse transform module 119 is the reconstructed residuals for the block in the pixel domain. The reconstructed residuals can be added to the prediction block 134 of the block to obtain a reconstructed block 136 in the pixel domain. For blocks where the transform is skipped, the inverse transform module 119 is not applied to those blocks. The de-quantized samples are the reconstructed residuals for the blocks.

Blocks in subsequent pictures following the first intra-predicted picture can be coded using either inter prediction or intra prediction. In inter-prediction, the prediction of a block in a picture is from one or more previously encoded video pictures. To perform inter prediction, the video encoder 100 uses an inter prediction module 124. The inter prediction module 124 is configured to perform motion compensation for a block based on the motion estimation provided by the motion estimation module 122.

The motion estimation module 122 compares a current block 104 of the current picture with decoded reference pictures 108 for motion estimation. The decoded reference pictures 108 are stored in a decoded picture buffer 130. The motion estimation module 122 selects a reference block from the decoded reference pictures 108 that best matches the current block. The motion estimation module 122 further identifies an offset between the position (e.g., x, y coordinates) of the reference block and the position of the current block. This offset is referred to as the motion vector (MV) and is provided to the inter prediction module 124 along with the selected reference block. In some cases, multiple reference blocks are identified for the current block in multiple decoded reference pictures 108. Therefore, multiple motion vectors are generated and provided to the inter prediction module 124 along with the corresponding reference blocks.

The inter prediction module 124 uses the motion vector(s) along with other inter-prediction parameters to perform motion compensation to generate a prediction of the current block, i.e., the inter prediction block 134. For example, based on the motion vector(s), the inter prediction module 124 can locate the prediction block(s) pointed to by the motion vector(s) in the corresponding reference picture(s). If there is more than one prediction block, these prediction blocks are combined with some weights to generate a prediction block 134 for the current block.

For inter-predicted blocks, the video encoder 100 can subtract the inter-prediction block 134 from block 104 to generate the residual block 106. The residual block 106 can be transformed, quantized, and entropy coded in the same way as the residuals of an intra-predicted block discussed above. Likewise, the reconstructed block 136 of an inter-predicted block can be obtained through inverse quantizing, inverse transforming the residual, and subsequently combining with the corresponding prediction block 134.

To obtain the decoded picture 108 used for motion estimation, the reconstructed block 136 is processed by an in-loop filter module 120. The in-loop filter module 120 is configured to smooth out pixel transitions thereby improving the video quality. The in-loop filter module 120 may be configured to implement one or more in-loop filters, such as a de-blocking filter, a sample-adaptive offset (SAO) filter, an adaptive loop filter (ALF), etc.

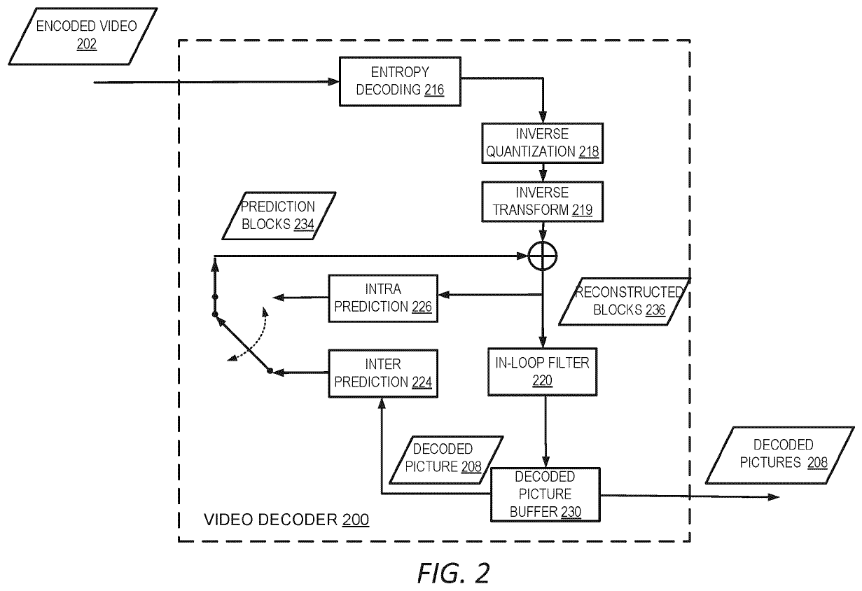

FIG. 2 depicts an example of a video decoder 200 configured to implement the embodiments presented herein. The video decoder 200 processes an encoded video 202 in a bitstream and generates decoded pictures 208. In the example shown in FIG. 2, the video decoder 200 includes an entropy decoding module 216, an inverse quantization module 218, an inverse transform module 219, an in-loop filter module 220, an intra prediction module 226, an inter prediction module 224, and a decoded picture buffer 230.

The entropy decoding module 216 is configured to perform entropy decoding of the encoded video 202. The entropy decoding module 216 decodes the quantized coefficients, coding parameters including intra prediction parameters and inter prediction parameters, and other information. In some examples, the entropy decoding module 216 decodes the bitstream of the encoded video 202 to binary representations and then converts the binary representations to quantization levels of the coefficients. The entropy-decoded coefficient levels are then inverse quantized by the inverse quantization module 218 and subsequently inverse transformed by the inverse transform module 219 to the pixel domain. The inverse quantization module 218 and the inverse transform module 219 function similarly to the inverse quantization module 118 and the inverse transform module 119, respectively, as described above with respect to FIG. 1. The inverse-transformed residual block can be added to the corresponding prediction block 234 to generate a reconstructed block 236. For blocks where the transform is skipped, the inverse transform module 219 is not applied to those blocks. The de-quantized samples generated by the inverse quantization module 118 are used to generate the reconstructed block 236.

The prediction block 234 of a particular block is generated based on the prediction mode of the block. If the coding parameters of the block indicate that the block is intra predicted, the reconstructed block 236 of a reference block in the same picture can be fed into the intra prediction module 226 to generate the prediction block 234 for the block. If the coding parameters of the block indicate that the block is inter-predicted, the prediction block 234 is generated by the inter prediction module 224. The intra prediction module 226 and the inter prediction module 224 function similarly to the intra prediction module 126 and the inter prediction module 124 of FIG. 1, respectively.

As discussed above with respect to FIG. 1, the inter prediction involves one or more reference pictures. The video decoder 200 generates the decoded pictures 208 for the reference pictures by applying the in-loop filter module 220 to the reconstructed blocks of the reference pictures. The decoded pictures 208 are stored in the decoded picture buffer 230 for use by the inter prediction module 224 and also for output.

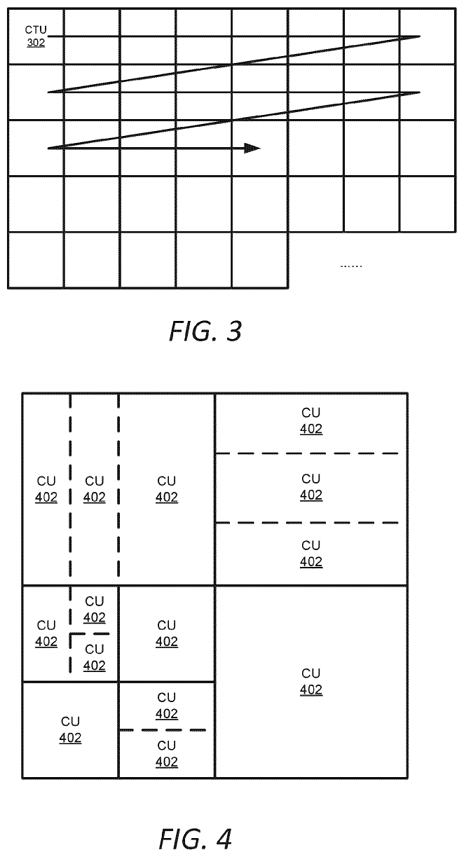

Referring now to FIG. 3, FIG. 3 depicts an example of a coding tree unit division of a picture in a video, according to some embodiments of the present disclosure. As discussed above with respect to FIGS. 1 and 2, to encode a picture of a video, the picture is divided into blocks, such as the CTUs (Coding Tree Units) 302 in VVC, as shown in FIG. 3. For example, the CTUs 302 can be blocks of 128×128 pixels. The CTUs are processed according to an order, such as the order shown in FIG. 3. In some examples, each CTU 302 in a picture can be partitioned into one or more CUs (Coding Units) 402 as shown in FIG. 4, which can be further partitioned into prediction units or transform units (TUs) for prediction and transformation. Depending on the coding schemes, a CTU 302 may be partitioned into CUs 402 differently. For example, in VVC, the CUs 402 can be rectangular or square, and can be coded without further partitioning into prediction units or transform units. Each CU 402 can be as large as its root CTU 302 or be subdivisions of a root CTU 302 as small as 4×4 blocks. As shown in FIG. 4, a division of a CTU 302 into CUs 402 in VVC can be quadtree splitting or binary tree splitting or ternary tree splitting. In FIG. 4, solid lines indicate quadtree splitting and dashed lines indicate binary or ternary tree splitting.

### Cross-Component Linear Model

A general tool employed in the hybrid video coding system such as VVC, HEVC, and other practical video coding standards, is the prediction of video pixels or samples in a block within a current frame to be decoded using pixels or samples from its spatial neighboring in the same frame which have already been reconstructed. Coding tools following this general architecture are commonly referred to as “intra-prediction” tools.

For typical video content, local correlations can be observed between the signals of different color components. For example, there may exist strong correlations among luma pixels and corresponding chroma pixels. In the HEVC range extensions, the cross-component prediction (CCP) tool exploits these correlations using a linear luma-to-chroma prediction model in the residual domain to code the transformed prediction residuals, where the parameters of the model are signaled in the bit stream. In VVC, cross-component linear model (CCLM) is an intra prediction technique to model the relationship between intra luma pixels and corresponding chroma pixels and makes use of inter-channel correlations by predicting the chroma samples from the corresponding reconstructed luma samples. This prediction P(i,j) is carried out using a linear model in the form of

$$P ( i , j ) = α \times r e {c}_{L} ( i , j ) + β \qquad ( 1 )$$

where P(i,j) represents the predicted chroma samples in a CU and rec_{L}(i,j) represents the reconstructed luma samples of the same CU which are down sampled for the case of non 4:4:4 color format. The linear model parameters α and β are derived based on the reconstructed neighboring luma and chroma samples at both encoder and decoder side without explicit signaling. Three CCLM modes, a one-model-left-top mode CCLM_LT, a one-model-left-only mode CCLM_L, and a one-model-top-only mode CCLM_T, are specified in the VVC. These three modes differ with respect to the locations of the reference samples that are used for model parameter derivation. Neighboring samples from the top boundary are involved in deriving the CCLM_T model and neighboring samples from the left boundary are involved in deriving the CCLM_L model. In the CCLM_LT mode, neighboring samples from both the top boundary and the left boundary are used in deriving the model. Overall, the prediction process of CCLM modes includes the following steps: down-sampling of the luma block and its neighboring reconstructed samples to match the size of the corresponding chroma block if necessary, deriving the model parameter based on the reconstructed neighboring luma and chroma samples, and applying the model as shown in Eqn. (1) to generate the chroma intra prediction samples.

To match the chroma sample locations for video sequences in 4:2:0 or 4:2:2 color format, two types of down-sampling filter can be applied to luma samples, both of which have a 2-to-1 down-sampling ratio in the horizontal and vertical directions. Based on the SPS-level flag information, the 2-dimensional 6-tap or 5-tap filter is applied to the luma samples within the current block as well as its neighboring luma samples. An exception happens if the top line of the current block is a CTU boundary. In this case, the one-dimensional filter [1, 2, 1]/4 is applied to the above neighboring luma samples in order to avoid the usage of more than one luma line above the CTU boundary.

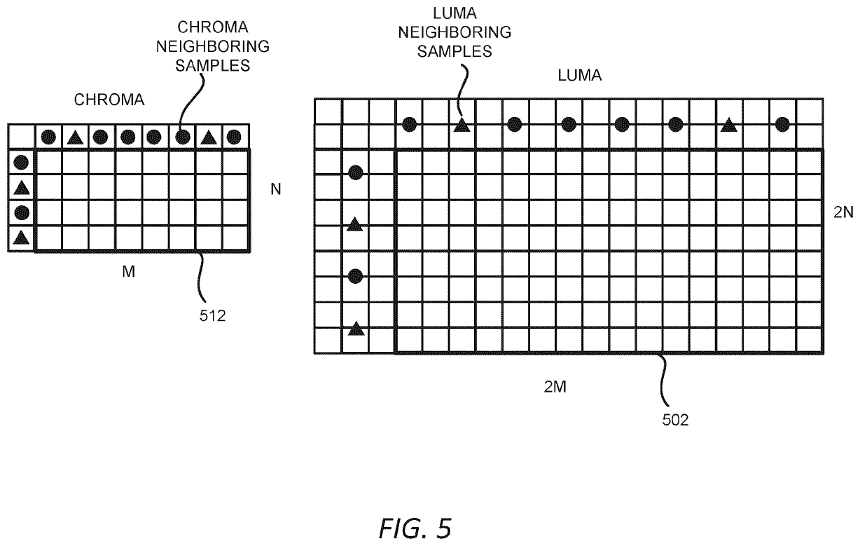

The model parameters α and β in Eqn. (1) can be derived based on the reconstructed neighboring luma and chroma samples at both encoder and decoder side to avoid any signaling overhead in the bitstream. A linear minimum mean square error (LMMSE) estimator can be used for derivation of the parameters. FIG. 5 depicts an example of a current chroma block 512 and the corresponding luma block 502 in a frame of a video for cross-component linear modeling, according to some embodiments of the present disclosure. In the example of FIG. 5, the chroma block 512 has a size of M×N and the corresponding luma block 502 has a size of 2M×2N. FIG. 5 also shows the neighboring samples of the luma block and the neighboring samples of the chroma block. The neighboring samples of the luma block and the chroma block is also referred to as a “template.”

In some implementations, to reduce the computational complexity, four out of the neighboring samples are involved in the model derivation. In FIG. 5, the four samples used in the CCLM_LT mode are marked with a triangular shape. These samples are located at the positions of M/4 and M×3/4 at the top boundary and at the positions of N/4 and N×3/4 at the left boundary. In the CCLM_T and CCLM_L modes, the top and left boundaries may be extended to a size of (M+N) samples, and the four samples used for model parameter derivation are located at the positions (M+N)/8, (M+N)×3/8, (M+N)×5/8 and (M+N)×7/8. Once the four samples are selected, four comparison operations are used to determine the two smallest and the two largest luma sample values among them. Let X₁ denote the average of the two largest luma sample values and let X₂ denote the average of the two smallest luma sample values. Similarly, let Y₁ and Y₂ denote the averages of the corresponding chroma sample values. Then, the linear model parameters can be obtained as following:

$$α = ( {Y}_{1} - {Y}_{2} ) / ( {X}_{1} - {X}_{2} ) \qquad ( 2 )$$

$$β = {Y}_{2} - α \times {X}_{2} \qquad ( 3 )$$

In this equation, the division operation to calculate the parameter a can be implemented with a look-up table to reduce the computational complexity of the encoder and decoder. To reduce the memory required for storing this table, a diff value, which is the difference between the maximum and minimum values, and the parameter a can be expressed by an exponential format. Here, the value of diff can be approximated with a 4-bit significant part and an exponent. Consequently, the table for 1/diff only consists of 16 elements. This has the benefit of both reducing the complexity of the calculation and decreasing the memory size required for storing the tables.

In further examples, more than one model, e.g., two models, may be used for cross-component prediction. As a result, there are three more CCLM models in addition to the three modes specified in VVC, including a two-model-left-top mode MMLM_LT, a two-model-left-only mode MMLM_L, and a two-model-top-only mode MMLM_T which represent using both top and left neighboring samples or using top neighboring samples only or using left neighboring samples only to derive two linear models, respectively.

A threshold agreed by both encoder and decoder can be used to classify all pixels in a current block into two categories. The threshold can be derived from neighboring luma template samples, such as by calculating the average of the neighboring luma template samples. If the down-sampled luma value of a position in the template is smaller than threshold, this position belongs to the first category; otherwise, it belongs to the second category. The down-sampled luma and corresponding chroma pixels in each category are used to derive the linear model for the category. Likewise, the corresponding luma pixels of the current chroma block can be categorized into two sets by comparing with the threshold and use the corresponding parameters of linear model to derive the prediction of each position in the chroma block.

In a further example, a slope adjustment can be used to update the derived model parameters α and β as follows:

$${α}^{′} = α + u \qquad ( 4 )$$

$${β}^{′} = β - u * {y}_{r} \qquad ( 5 )$$

where u is a slope adjustment which is coded in the bitstream; α′ and β′ are the updated slope and offset, respectively; yᵣ is the average of the template luma samples, α′ and β′ can be used as linear model parameters to calculate the prediction of chroma block instead of the derived α and β from the templates. Currently, the slope adjustment is just applied to CCLM_LT and MMLM_LT.

In the existing methods, the cross-component linear model and the adjustment to the model are based on neighbouring template information. Despite the spatial closeness of the neighbouring template to the current block, the model may not reflect the actual relationship between chroma pixels in the current chroma block and the corresponding luma pixels at the corresponding positions. For example, samples from the neighbouring template and the current block may belong to different objects in the video scene, with different texture characteristics. As such, the derived CCLM model is not accurate for predicting chroma samples of the current chroma block. To solve these problems, the cross-component linear model can be adjusted or updated by considering the pixels in the current block thereby improving the accuracy of the model.

In one embodiment, to improve the accuracy of cross-component linear models, the slope adjustment can also be applied to CCLM modes in addition to CCLM_LT and MMLM_LT, such as CCLM_L, CCLM_T, MMLM_L and MMLM_T. The slope adjustment could be applied to all of these modes, or any subset of these modes. As one example, the slope adjustment is applied to CCLM_LT, MMLM_LT, CCLM_L and CCLM_T. In another example, the slope adjustment is applied to all the CCLM modes, including CCLM_LT, MMLM_LT, CCLM_L, CCLM_T, MMLM_L and MMLM_T.

In another embodiment, in order to efficiently code the delta slope u in Eqn. (4), a syntax element abs_delta_slope_greater0_flag can be first coded to indicate if the absolute value of delta slope is equal to 0. If abs_delta_slope_greater0_flag is not zero, syntax element abs_delta_slope_greaterl_flag can be coded to indicate if the absolute delta slope is greater than 1 or not. If abs_delta_slope_greaterl_flag is greater than 1, the syntax element abs_delta_slope_minus2 can be coded to indicate the value of the absolute value of delta slope factor minus 2. In addition, if the absolute value of the delta slope is not zero, syntax element delta_slope_sign_flag will be coded to indicate the sign of the delta slope (e.g., positive or negative). A possible syntax representation is shown below in Table 1.

TABLE 1
Syntax representation for coding delta scale

| | Descriptor |
|---|---|
| delta_scale_coding( ) { | |
| abs_delta_slope_greater0_flag | ae(v) |
| if( abs_delta_slope_greater0_flag ) | |
| abs_delta_slope_greater1_flag | ae(v) |
| if( abs_delta_slope_greater0_flag ) { | |
| if( abs_delta_slope_greater1_flag ) | |
| abs_delta_slope_minus2 | ae(v) |
| delta_slope_sign_flag | ae(v) |
| } | |
| } | |

In another embodiment, to further improve the accuracy of the cross-component linear model thereby improving the coding efficiency, both the slope and the offset parameters of the model are adjusted to match the respective parameters of the model derived using the samples of the chroma block and the reconstructed samples of the corresponding luma block (which may be referred to as the “actual cross-component linear model”). The adjustment can be represented using delta slope and delta offset. Denote the delta slope and delta offset as dₛ and dₒ, respectively. The updated slope α_{updated} and updated offset β_{updated} can be calculated at the decoder side as follows:

$${α}_{updated} = α + {d}_{s} \qquad ( 6 )$$

$${β}_{updated} = β + {d}_{o} \qquad ( 7 )$$

Here, α and β are the parameters of the cross-component linear model derived using neighboring reconstructed luma and chroma samples as described above. The cross-component linear model with parameters α and β is referred to as a “base model.” The slope and offset parameters of the actual model can also be derived for the block by the encoder using the chroma samples of a block and the corresponding reconstructed luma samples. For example, at the encoding side, the slope and offset of the actual model for the current chroma block (denoted as α_{org} and β_{org}, respectively) could be calculated through LMMSE by using original chroma value and corresponding down-sampled reconstructed luma pixels. In order for the decoder to have access to the actual slope and offset, the delta slope and offset, dₛ and dₒ, can be determined and transmitted in the bitstream. The delta slope and offset, dₛ and dₒ could be calculated as follows.

$${d}_{s} = {α}_{o r g} - α \qquad ( 8 )$$

$${d}_{o} = {β}_{o r g} - β \qquad ( 9 )$$

Both dₛ and dₒ may be coded using syntax elements in a way similar to Table 1. Because the slope and offset parameters α_{org} and β_{org} are derived using the chroma samples of the block, instead of the neighboring samples, the updated model with parameters α_{updated} and β_{updated} is more accurate in predicting the chroma block from the luma block than the base model.

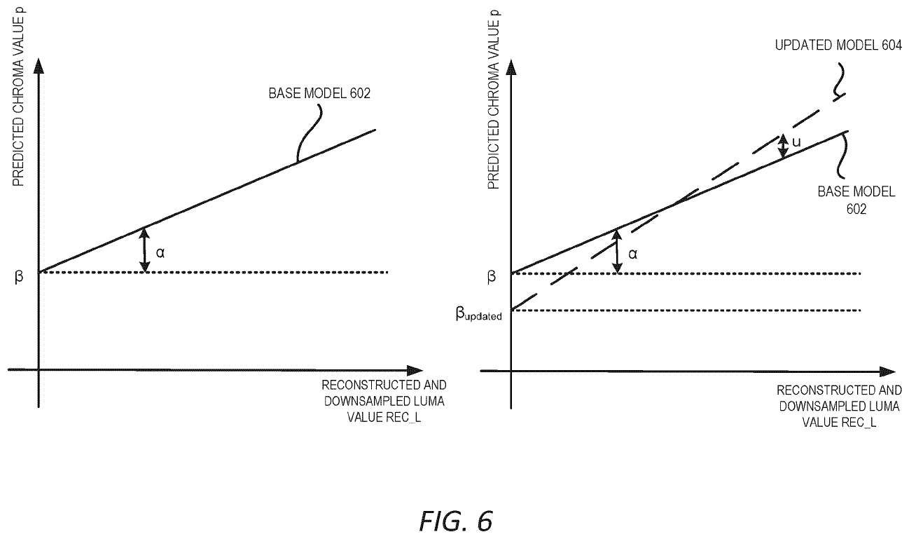

FIG. 6 depicts an example of a linear model for cross-component prediction and the model adjustment, according to some embodiments of the present disclosure. The base cross-component linear model 602 is shown on the left side of FIG. 6 and the updated cross-component linear model 604 with parameter adjustments is shown on the right side of FIG. 6 along with the base model 602. In FIG. 6, the base model 602 is shown in a solid line and the updated model 604 is shown in a dashed line. Compared with the base model 602, the updated model 604 may have both the slope parameter a and the offset parameter β adjusted.

In the embodiments described above, the use of the encoded parameter adjustments may be signaled at different levels in the bitstream and be enabled or disabled. For example, at the sequence parameter set (SPS) level, the signaling can be added as follows (additions are shown as underlined):

| | Descriptor |
|---|---|
| seq_parameter_set_rbsp( ) { | |
| sps_seq_parameter_set_id | u(4) |
| ...... | |
| sps_cclm_delta_flag | u(1) |
| ...... | |
| ...... | |
| ...... | |
| } | |

sps_cclm delta flag equal to 1 specifies that the delta based CCLM is enabled for the coded layer video sequence (CLVS). sps_cclm delta flag equal to 0 specifies that the delta based CCLM is disabled for the CLVS.

| | Descriptor |
|---|---|
| pic_parameter_set_rbsp( ) { | |
| pps_pic_parameter_set_id | u(6) |
| ...... | |
| if(sps_cclm_delta_flag) | |
| pps_cclm_delta_flag | u(1) |
| ...... | |
| } | |

pps_cclm delta flag equal to 1 specifies that the delta based CCLM is enabled for the current picture. pps_cclm delta flag equal to 0 specifies that the delta based CCLM is disabled for the current picture. When not present, the value of pps_cclm delta flag is inferred to be equal to 0.

| | Descriptor |
|---|---|
| slice_header( ) { | |
| sh_picture_header_in_slice_header_flag | u(1) |
| ...... | |
| if(pps_cclm_delta_flag ) | |
| sh_cclm_delta_flag | u(1) |
| ...... | |
| } | |

sh_cclm delta flag equal to 1 specifies that the delta based CCLM is enabled for the current slice. sh_cclm delta flag equal to 0 specifies that the delta based CCLM is disabled for the current slice. When not present, the value of sh_cclm delta flag is inferred to be equal to 0.

To signal the specific mode used in the cross-component prediction, syntax elements can be used for each block. For example, the six CCLM modes can be coded with the following syntax table. First, isCCLM_flag is coded to indicate if the current chroma mode is CCLM or not. If the current chroma mode is a CCLM mode, CCLM_flag is coded to indicate if the current chroma mode is a one-model CCLM or not. If the current chroma mode is not a one-model CCLM, MMLM_flag is coded to indicate if the current chroma mode is a two-model CCLM or not. If the current chroma mode is not a two-model CCLM, MDLM_L_flag is coded to indicate if the current chroma mode is a one-model using left template only CCLM (CCLM_L). If the current chroma mode is not a one-model using left template only CCLM, MDLM_T_flag is coded to indicate if the current chroma mode is a one-model using top template only CCLM (CCLM_T). If the current chroma mode is not a one-model using top template only CCLM, MMLM_L_flag is coded to indicate if the current chroma mode is a two-model using left or top template only CCLM (MMLM_L or MMLM_T).

| | |
|---|---|
| isCCLM_flag | ae(v) |
| if(isCCLM_flag){ //using CCLM | |
| CCLM_flag // 0: single CCLM, | ae(v) |
| if(CCLM_flag){ | |
| MMLM_flag // 0: MMLM | ae(v) |
| if(MMLM_flag){ | |
| MDLM_L_flag // 0: MDLM_L | ae(v) |
| if(MDLM_L_flag) { | |
| MDLM_T_flag // 0: MDLM_T | ae(v) |
| if(MDLM_T_flag){ | |
| MMLM_L_flag //0: MMLM_L, 1: MMLM_T | ae(v) |
| } // MDLM_T_flag | |
| } // MDLM_L_flag | |
| }// MMLM_flag | |
| } // CCLM_flag | |
| } // isCCLM_flag | |

isCCLM_flag equal to 0 specifies that the current chroma mode is not a CCLM mode. isCCLM_flag equal to 1 specifies that the current chroma mode is a CCLM mode.
CCLM_flag equal to 0 specifies that the current chroma mode is a one-model CCLM (CCLM_LT) mode. CCLM_flag equal to 1 specifies that the current chroma mode is not a one-model CCLM mode.
MMLM_flag equal to 0 specifies that the current chroma mode is a two-model CCLM (MMLM_LT) mode. MMLM_flag equal to 1 specifies that the current chroma mode is not a two-model CCLM mode.
MDLM_L_flag equal to 0 specifies that the current chroma mode is a one-model using left template only CCLM (CCLM_L) mode. MDLM_L_flag equal to 1 specifies that the current chroma mode is not a one-model using left template only CCLM mode.
MDLM_T_flag equal to 0 specifies that the current chroma mode is a one-model using top template only CCLM (CCLM_T) mode. MDLM_T_flag equal to 1 specifies that the current chroma mode is not a one-model using top template only CCLM mode.
MMLM_L_flag equal to 0 specifies that the current chroma mode is a two-model using left template only CCLM (MMLM_L) mode. MMLM_L_flag equal to 1 specifies that the current chroma mode is a two-model using top template only CCLM (MMLM_T) mode.

For a rectangular block, it may not be necessary to use both left and top template only models. As such, only left- or top-only-template CCLM model (CCLM_T, MMLM_T, CCLM_L, or MMLM_L) can be used for a rectangular block, depending on if width or height of the current block is larger. More specifically, a variable isSquareBlk can be used to indicate if the current block is a square or not. If the current block is a square block, the parsing of syntax elements and meaning of these syntax elements keep unchanged. If the current block is not a square block, MDLM_T_flag and MMLM_L_flag are never parsed. In the meantime, if the width of the current block is not smaller than the height of the current block, MDLM_L_flag equal to 0 specifies that the current chroma mode is a one-model using top template only CCLM (CCLM_T). MDLM_L_flag equal to 1 specifies that the current chroma mode is a two-model using top template only CCLM (MMLM_T).

If the width of the current block is smaller than the height of the current block, MDLM_L_flag equal to 0 specifies that the current chroma mode is a one-model mode using left template only CCLM (CCLM_L). MDLM_L_flag equal to 1 specifies that the current chroma mode is a two-model mode using left template only CCLM (MMLM_L). The modified syntax table is shown as follows (additions are underlined).

| | |
|---|---|
| isCCLM_flag | ae(v) |
| if(isCCLM_flag){ //using CCLM | |
| CCLM_flag // 0: single CCLM, | ae(v) |
| if(CCLM_flag){ | |
| MMLM_flag // 0: MMLM | ae(v) |
| if(MMLM_flag){ | |
| MDLM_L_flag // 0: MDLM_L | ae(v) |
| if( isSquareBlk && MDLM_L_flag) { | |
| MDLM_T_flag // 0: MDLM_T | ae(v) |
| if(MDLM_T_flag){ | |
| MMLM_L_flag //0: MMLM_L, 1: MMLM_T | ae(v) |
| } // MDLM_T_flag | |
| } // isSquareBlk && MDLM_L_flag | |
| }// MMLM_flag | |
| } // CCLM_flag | |
| } // isCCLM_flag | |

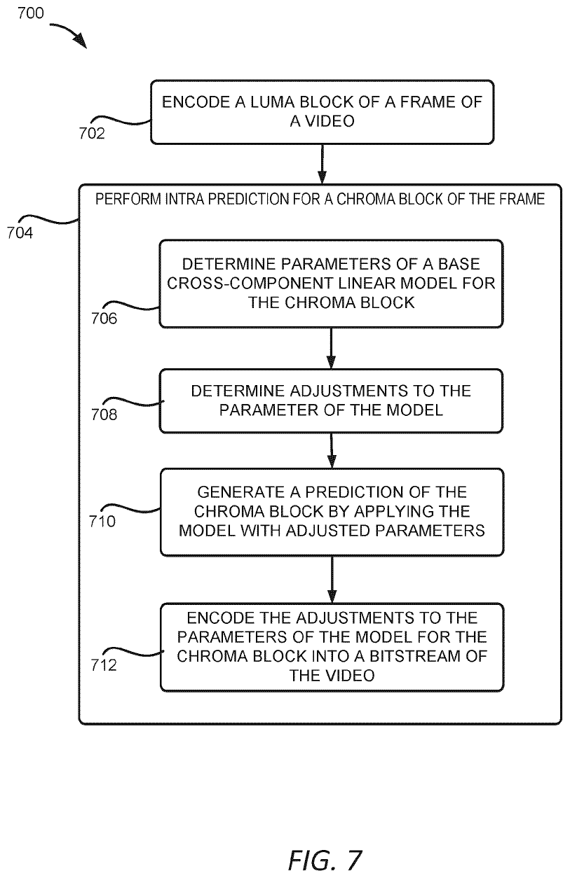

FIG. 7 depicts an example of a process 700 for performing intra prediction for a frame of a video with cross-component prediction, according to some embodiments of the present disclosure. One or more computing devices (e.g., the computing device implementing the video encoder 100) implement operations depicted in FIG. 7 by executing suitable program code (e.g., the program code implementing the intra prediction module 126). For illustrative purposes, the process 700 is described with reference to some examples depicted in the figures. Other implementations, however, are possible.

At block 702, the process 700 involves encoding a luma block of a frame of a video signal. A block can be a portion of a frame, such as a coding unit 402 discussed in FIG. 4 or any type of block processed by a video encoder as a unit when performing the encoding. In addition, each frame of the video has a luminance component (e.g., Y component) and two chrominance components (U and V components). Depending on the color format of the frame, the chroma components may be subsampled compared with the luma component (e.g., for 4:2:2 or 4:2:0 formats). As such, each block of the frame can include a luma block and two corresponding chroma blocks which may be down-sampled. For each block of the frame, the luma block is first encoded, such as using the intra-prediction described above with respect to FIG. 1.

At block 704, which includes blocks 706-712, the process 700 involves performing intra prediction for each chroma block in the frame. At block 706, the process 700 involves determining parameters of a base cross-component linear model for the chroma block based on reconstructed pixels in the luma component and chroma component of the frame. For example, as discussed above in detail with respect to FIG. 5, the parameters of a base cross-component linear model can be determined via a linear minimum mean square error (LMMSE) estimator or similar method using the reconstructed luma neighboring samples of the luma block and the reconstructed chroma neighboring sample of the chroma block. If the chroma block has a lower dimension than the luma block, the reconstructed luma neighboring samples of the luma block are generated by down-sampling the reconstructed pixels that neighbors the luma block.

At block 708, the process 700 involves determining an adjustment to the parameters of the cross-component linear model. As discussed above, the encoder can determine the adjustment for the slope parameter and the adjustment for the offset parameter by determining the differences between the parameters of a more accurate actual model and the parameters of the base model. The actual model can be derived using the reconstructed (and down-sampled) pixels in the luma block and the original pixels in the chroma block through, for example, the LMMSE estimator.

At block 710, the process 700 involves generating a prediction of the chroma block by applying the cross-component linear model with adjusted parameters to the reconstructed samples in the luma block. In scenarios where the chroma block has a lower dimension than the luma block, the reconstructed samples of the luma block are down-sampled before being provided to the model as input.

At block 712, the process 700 involves encoding the adjustments to the parameters of the cross-component linear model in a bitstream of the video. Both adjustments to the slope and the offset may be encoded into the bitstream according to the syntax representation shown in Table 1 and the signaling mechanism as described above. Other data, such as the prediction residual for the chroma block, are also encoded in the bitstream. Blocks 704-712 can be repeated for another chroma block associated with the same block of the frame.

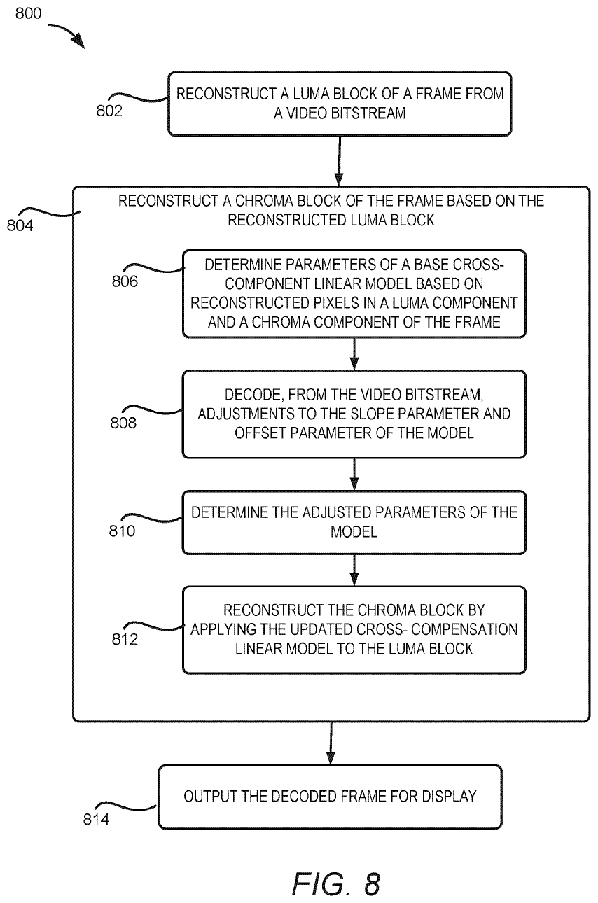

FIG. 8 depicts an example of a process 800 for decoding an intra-predicted frame of a video that is encoded with cross-component prediction, according to some embodiments of the present disclosure. One or more computing devices implement operations depicted in FIG. 8 by executing suitable program code. For example, a computing device implementing the video decoder 200 may implement the operations depicted in FIG. 8 by executing the program code for the intra prediction module 226. For illustrative purposes, the process 800 is described with reference to some examples depicted in the figures. Other implementations, however, are possible.

At block 802, the process 800 involves reconstructing a luma block of a frame of a video from a video bitstream representing the video, for example, using the decoding method described above with respect to FIG. 2. At block 804, which includes 806-812, the process 800 involves reconstructing a chroma block of the frame based on the reconstructed luma block. At block 806, the process 800 involves determining parameters of a base local illumination compensation model using the reconstructed pixels in a luma component of the frame and a chroma component of the frame. For example, as discussed above in detail with respect to FIG. 5, the parameters of the base cross-component linear model can be determined via a linear minimum mean square error (LMMSE) estimator or similar method using the reconstructed luma neighboring samples of the luma block and the reconstructed chroma neighboring sample of the chroma block. If the chroma block has a lower dimension than the luma block, the reconstructed luma neighboring samples of the luma block are generated by down-sampling the reconstructed pixels that neighbors the luma block.

At block 808, the process 800 involves decoding, from the video bitstream, an adjustment to the slope parameter and an adjustment to the offset parameter of the base cross-component linear model. The decoding can be performed according to the syntax representation shown in Table 1. In some examples, the decoding further includes decoding, from the video bitstream, the CCLM mode according to the signaling mechanism as described above.

At block 810, the process 800 involves determining the adjusted slope and offset parameters of the cross-component linear model to obtain an updated cross-component linear model. The adjusted slope and offset can be calculated according to Eqns. (6) and (7) as discussed above. At block 812, the process 800 involves reconstructing the chroma block. The decoder can generate a prediction for the chroma block by applying the updated cross-component linear model to the reconstructed luma block which is down-sampled if necessary. The prediction can be used to reconstruct the chroma block by combining with other data associated with the chroma block, such as the predicted residual. The reconstructed chroma block may also be used to perform intra prediction for other blocks of the frame by the decoder. Blocks 806-812 may be repeated for each chroma block corresponding to the luma block. At block 814, the reconstructed block may also be output for displaying along with other decoded blocks in the frame.

It should be understood that the examples described above are for illustration purposes and should not be construed as limiting. Different implementations may be employed to generate and update the local illumination compensation model. For example, instead of the L-shape template shown in FIG. 5, templates with other shapes may be used. In a further example, multiple columns of left neighboring pixels and/or multiple rows of top neighboring pixels may be used as the template. Further, while the above description focusses on a linear function used for the cross-component prediction, other types of functions may also be used. For example, a general higher polynomial function, such as a second-degree polynomial function can be used to model the cross-component relationship between chroma pixels in a chroma block and the corresponding luma pixels in the corresponding luma block.

### Computing System Example

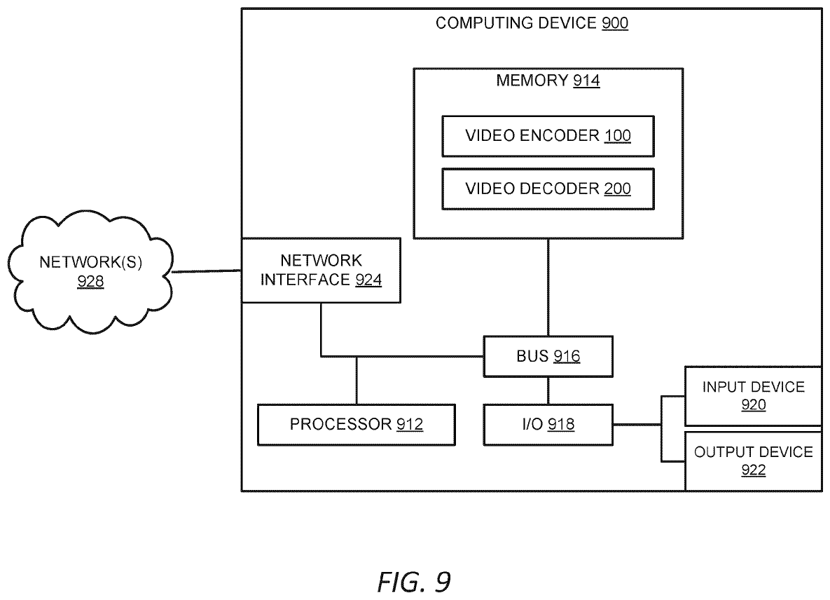

Any suitable computing system can be used for performing the operations described herein. For example, FIG. 9 depicts an example of a computing device 900 that can implement the video encoder 100 of FIG. 1 or the video decoder 200 of FIG. 2. In some embodiments, the computing device 900 can include a processor 912 that is communicatively coupled to a memory 914 and that executes computer-executable program code and/or accesses information stored in the memory 914. The processor 912 may comprise a microprocessor, an application-specific integrated circuit (“ASIC”), a state machine, or other processing device. The processor 912 can include any of a number of processing devices, including one. Such a processor can include or may be in communication with a computer-readable medium storing instructions that, when executed by the processor 912, cause the processor to perform the operations described herein.

The memory 914 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 900 can also include a bus 916. The bus 916 can communicatively couple one or more components of the computing device 900. The computing device 900 can also include a number of external or internal devices such as input or output devices. For example, the computing device 900 is shown with an input/output (“I/O”) interface 918 that can receive input from one or more input devices 920 or provide output to one or more output devices 922. The one or more input devices 920 and one or more output devices 922 can be communicatively coupled to the I/O interface 918. The communicative coupling can be implemented via any suitable manner (e.g., a connection via a printed circuit board, connection via a cable, communication via wireless transmissions, etc.). Non-limiting examples of input devices 920 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 922 include an LCD screen, an external monitor, a speaker, or any other device that can be used to display or otherwise present outputs generated by a computing device.

The computing device 900 can execute program code that configures the processor 912 to perform one or more of the operations described above with respect to FIGS. 1-8. The program code can include the video encoder 100 or the video decoder 200. The program code may be resident in the memory 914 or any suitable computer-readable medium and may be executed by the processor 912 or any other suitable processor.

The computing device 900 can also include at least one network interface device 924. The network interface device 924 can include any device or group of devices suitable for establishing a wired or wireless data connection to one or more data networks 928. Non-limiting examples of the network interface device 924 include an Ethernet network adapter, a modem, and/or the like. The computing device 900 can transmit messages as electronic or optical signals via the network interface device 924.

### General Considerations

Numerous details are set forth herein to provide a thorough understanding of the claimed subject matter. However, those skilled in the art will understand that the claimed subject matter may be practiced without these details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Some blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method for decoding an intra-predicted frame of a video that is encoded with cross-component prediction, the method comprising:
reconstructing a luma block of a frame of the video from a video bitstream representing the video;
reconstructing a chroma block of the frame that corresponds to the luma block based on the reconstructed luma block by:
determining a first parameter and a second parameter of a cross-component linear model based on a first set of reconstructed pixels in a chroma component of the frame and a second set of samples generated from reconstructed pixels in a luma component of the frame,
decoding, from the video bitstream, a first adjustment to the first parameter and a second adjustment to the second parameter,
adjusting the first parameter and the second parameter by applying the first adjustment to the first parameter and applying the second adjustment to the second parameter, and
reconstructing pixels of the chroma block by applying, to the luma block, the cross-component linear model with the adjusted first parameter and the adjusted second parameter; and
causing the reconstructed frame to be displayed.

2. The method of claim 1, wherein the cross-component linear model is a linear model with the first parameter representing a slope and the second parameter representing an offset.

3. The method of claim 1, wherein applying, to the luma block, the cross-component linear model with the adjusted first parameter and the adjusted second parameter comprises:
down-sampling the luma block; and
using the down-sampled luma block as input to the cross-component linear model with the adjusted first parameter and the adjusted second parameter.

4. The method of claim 1, wherein the first set of reconstructed pixels in the chroma component of the frame comprises two or more reconstructed neighboring samples of the chroma block, and wherein the second set of samples generated from the reconstructed pixels in the luma component of the frame comprises two or more samples derived from reconstructed neighboring samples of the luma block.

5. The method of claim 1, wherein the first adjustment to the first parameter and the second adjustment to the second parameter are determined based on reconstructed pixels in the luma block and original pixels in the chroma block.

6. The method of claim 1, wherein the first adjustment to the first parameter is encoded into the video bitstream via syntax elements comprising a first syntax element indicating a sign of the first adjustment and a second syntax element indicating a relationship between an absolute value of the first adjustment and a pre-determined value.

7. The method of claim 1, wherein the cross-component linear model has a mode selected from a set of modes comprising a one-model-top-only mode, a one-model-left-only mode, a one-model-left-top mode, a two-model-top-only mode, a two-model-left-only mode, and a two-model-left-top mode, and wherein the mode of the cross-component linear model is selected based on whether the chroma block is a square block or not.

8-14. (canceled)

15. A system comprising:
a processing device; and
a non-transitory computer-readable medium communicatively coupled to the processing device, wherein the processing device is configured to execute program code stored in the non-transitory computer-readable medium and thereby perform operations comprising:
reconstructing a luma block of a frame of a video that is encoded with cross-component prediction from a video bitstream representing the video;
reconstructing a chroma block of the frame that corresponds to the luma block based on the reconstructed luma block by:
determining a first parameter and a second parameter of a cross-component linear model based on a first set of reconstructed pixels in a chroma component of the frame and a second set of samples generated from reconstructed pixels in a luma component of the frame,
decoding, from the video bitstream, a first adjustment to the first parameter and a second adjustment to the second parameter,
adjusting the first parameter and the second parameter by applying the first adjustment to the first parameter and applying the second adjustment to the second parameter, and
reconstructing pixels of the chroma block by applying, to the luma block, the cross-component linear model with the adjusted first parameter and the adjusted second parameter; and
causing the reconstructed frame to be displayed.

16. The system of claim 15, wherein applying, to the luma block, the cross-component linear model with the adjusted first parameter and the adjusted second parameter comprises:
down-sampling the luma block; and
using the down-sampled luma block as input to the cross-component linear model with the adjusted first parameter and the adjusted second parameter.

17. The system of claim 15, wherein the first set of reconstructed pixels in the chroma component of the frame comprises two or more reconstructed neighboring samples of the chroma block, and wherein the second set of samples generated from the reconstructed pixels in the luma component of the frame comprises two or more samples derived from reconstructed neighboring samples of the luma block.

18. The system of claim 15, wherein the first adjustment to the first parameter and the second adjustment to the second parameter are determined based on reconstructed pixels in the luma block and original pixels in the chroma block.

19. The system of claim 15, wherein the first adjustment to the first parameter is encoded into the video bitstream via syntax elements comprising a first syntax element indicating a sign of the first adjustment and a second syntax element indicating a relationship between an absolute value of the first adjustment and a pre-determined value.

20. The system of claim 15, wherein the cross-component linear model has a mode selected from a set of modes comprising a one-model-top-only mode, a one-model-left-only mode, a one-model-left-top mode, a two-model-top-only mode, a two-model-left-only mode, and a two-model-left-top mode, and wherein the mode of the cross-component linear model is selected based on whether the chroma block is a square block or not.

21. A method for intra predicting a frame of a video with cross-component prediction, the method comprising, for each block of the frame:
encoding a luma block of the frame of the video;
performing intra prediction for a chroma block of the frame that corresponds to the luma block by:
determining a first parameter and a second parameter of a cross-component linear model based on a first set of reconstructed pixels in a chroma component of the frame and a second set of samples generated from reconstructed pixels in a luma component of the frame that corresponds to the first set of reconstructed pixels in the chroma component,
determining a first adjustment to the first parameter and a second adjustment to the second parameter, and
generating a prediction for the chroma block by applying, to the luma block, the cross-component linear model with an adjusted first parameter by the first adjustment and an adjusted second parameter by the second adjustment; and
encoding the first adjustment to the first parameter and the second adjustment to the second parameter into a bitstream representing the video.

22. The method of claim 21, wherein the cross-component linear model is a linear model with the first parameter representing a slope and the second parameter representing an offset.

23. The method of claim 21, wherein applying, to the luma block, the cross-component linear model with the adjusted first parameter and the adjusted second parameter comprises:
down-sampling the reconstructed pixels in the luma block; and
using the down-sampled luma block as input to the cross-component linear model with the adjusted first parameter and the adjusted second parameter.

24. The method of claim 21, wherein the first set of reconstructed pixels in the chroma component of the frame comprises two or more reconstructed neighboring samples of the chroma block, and wherein the second set of samples generated from the reconstructed pixels in the luma component of the frame comprises two or more samples derived from reconstructed neighboring samples of the luma block.

25. The method of claim 21, wherein the first adjustment to the first parameter and the second adjustment to the second parameter are determined based on reconstructed pixels in the luma block and original pixels in the chroma block.

26. The method of claim 21, wherein the first adjustment to the first parameter is encoded into the video bitstream via syntax elements comprising a first syntax element indicating a sign of the first adjustment and a second syntax element indicating a relationship between an absolute value of the first adjustment and a pre-determined value.

27. The method of claim 21, wherein the cross-component linear model has a mode selected from a set of modes comprising a one-model-top-only mode, a one-model-left-only mode, a one-model-left-top mode, a two-model-top-only mode, a two-model-left-only mode, and a two-model-left-top mode, and wherein the mode of the cross-component linear model is selected based on whether the chroma block is a square block or not.

28-40. (canceled)
